(19) United States
(12) Patent Application Publication
(10) Pub. No.: US 2007/0224890 A1
(43) Pub. Date: Sep. 27, 2007

(54) Contact for a battery connector

(75) Inventors: Ming-Lung Chien, Hsin-Tien City (TW); Hsueh-Chih Cheng, Hsin-Tien City (TW); Jian Cheng, Hsin-Tien City (TW); Shan-Ji Zhao, Hsin-Tien City (TW)

Correspondence Address: BIRCH STEWART KOLASCH & BIRCH, PO BOX 747, FALLS CHURCH, VA, 22040-0747, US

(73) Assignee: Advanced-Connectek Inc.

(21) Appl. No.: 11/710,504

(22) Filed: Feb. 26, 2007

(30) Foreign Application Priority Data
Mar. 24, 2006 (CN) 095204988

(51) Int. Cl. H01R 4/48

(52) U.S. Cl. 439/862

(57) ABSTRACT

A contact is mounted in a battery connector of an electronic device and has a soldering section, a body section, a resilient section, two inclined gaps and a contacting section. The body section extends from the soldering section and has a first end and a second end. The resilient section extends from the body section and has a first end, a second end and a tapered segment. The first end of the resilient section is connected to the second end of the body section. The tapered segment is tapered toward the first end of the resilient section. The inclined gaps are defined in the second end of the body section to form the tapered segment. The contacting segment extends from the second end of the resilient section. With the inclined gaps, the contact is compact, resilient and has a low material cost.

### BACKGROUND OF THE INVENTION

1. Field of the Invention

The present invention relates to a contact, and more particularly to a contact that is mounted in a battery connector of an electronic device.

2. Description of Related Art

As the electronic technology develops, electronic devices become more and more compact and an internal cavity in an electronic device becomes smaller and smaller. Accordingly, electronic components such as chips, capacitors, resistors and contacts in the internal cavity have to be sized smaller in order to be mounted tightly together.

A conventional battery connector of an electronic device has multiple contacts. Each contact has a soldering section, a body section, a resilient section and a contacting section. The soldering section is soldered on a printed circuit board (PCB). The body section is formed on the soldering section, is mounted on the PCB through an insulating compound and has two notches. The notches are defined in the body section to engage with the hardened insulating compound. The resilient section is formed on the body section.

To mount the contact in a narrow cavity in the battery connector, a length of the contact has to be reduced. Therefore, the body section or the resilient section is shortened. However, shortening the body section weakens an engagement of the body section and the PCB so that the contact easily sways. Alternatively, shortening the resilient section decreases a resilience of the contact and easily breaks. Consequently, a shortened contact is non-durable no matter which of the body and resilient sections is shortened.

To overcome the shortcomings, the present invention provides a contact to mitigate or obviate the aforementioned problems.

### SUMMARY OF THE INVENTION

The main object of the invention is to provide a contact that is mounted in a battery connector of an electronic device, is firm and resilient, is compact and has a low material cost.

A contact in accordance with the present invention is mounted in a battery connector of an electronic device and comprises a soldering section, a body section, a resilient section, two opposite inclined gaps and a contacting section.

The body section extends from the soldering section and has a first end and a second end.

The resilient section extends from the body section and has a first end, a second end and a tapered segment.

The first end of the resilient section is connected to the second end of the body section. The tapered segment is tapered toward the first end of the resilient section.

The inclined gaps are defined in the second end of the body section to form the tapered segment.

The contacting segment extends from the second end of the resilient section.

Other objects, advantages and novel features of the invention will become more apparent from the following detailed description when taken in conjunction with the accompanying drawings.

### BRIEF DESCRIPTION OF THE DRAWINGS

FIG. 1 is a plane view of a contact in accordance with present invention with the contact spreading in a plane for illustration;

FIG. 2 is a perspective view of the contact in FIG. 1;

FIG. 3 is a perspective view of the contacts in FIG. 1 mounted in an insulative housing to form a battery connector; and

FIG. 4 is an operational perspective view of the battery connector shown in FIG. 3 mounted on a printed circuit board, in which the contacts are electrically connected to a battery.

### DETAILED DESCRIPTION OF THE PREFERRED EMBODIMENT

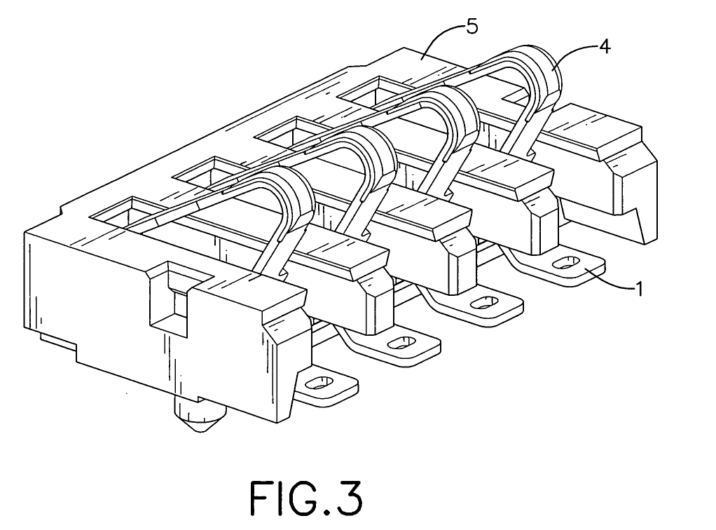

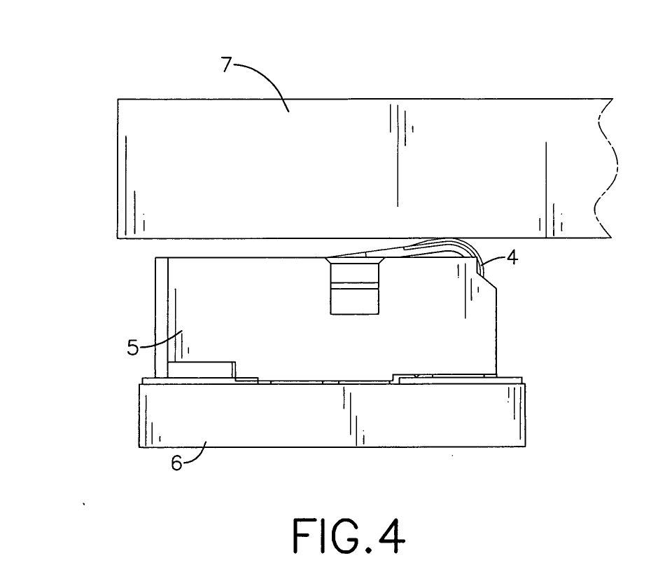

With reference to FIGS. 3 and 4, contacts in accordance with the present invention are mounted to an insulative housing to form a battery connector. The battery connector is mounted to a printed circuit board (PCB) 6 and the contacts may contact a battery 7.

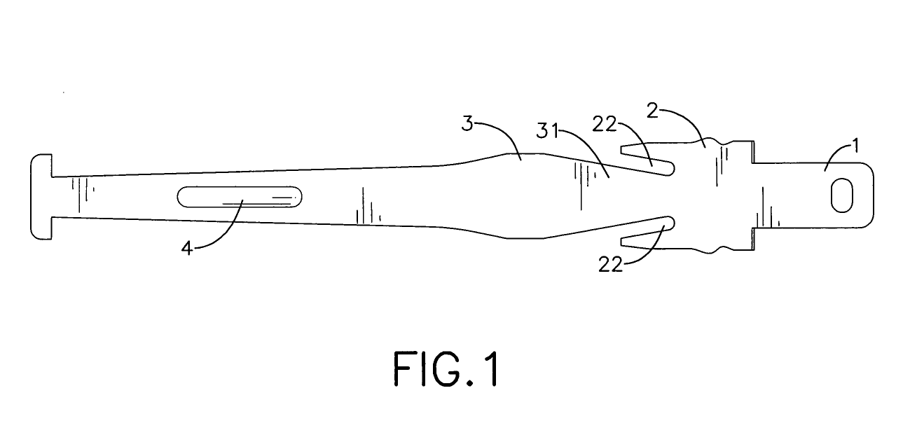

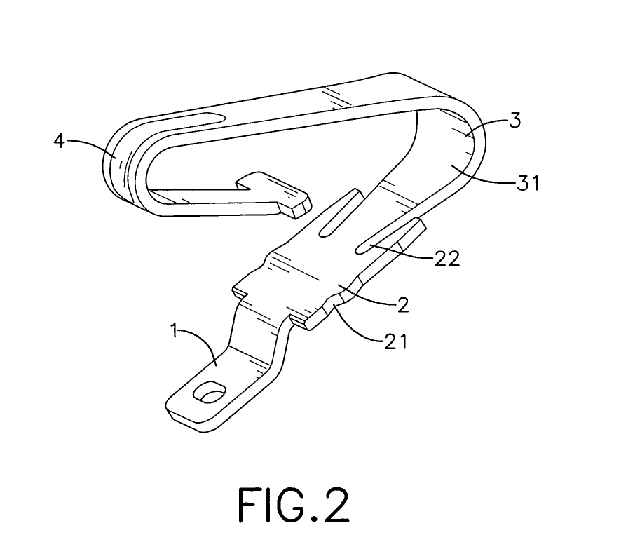

With reference to FIGS. 1 and 2, each contact comprises a soldiering section 1, a body section 2, a resilient section 3, two opposite inclined gaps 22 and a contacting section 4.

The soldering section 1 may soldered on the PCB in the battery connector of the electronic device.

The body section 2 is formed on and extends from the soldering section 1, may be fastened on the PCB through an insulating compound and has a first end, a second end, two opposite sides and two notches 21. The first end is connected to the soldering section 1. The notches 21 are V-shaped and are transversely defined respectively in the sides. The notches 21 may engage with the hardened insulating compound to securely mount the contact on the PCB and prevent the contact from swaying.

The resilient section 3 bends to be U-shaped, is resilient, is formed on and extends from the second end of the body section 2 and has a first end, a second end, two opposite sides and a tapered segment 31. The first end of the resilient section 3 is connected to the second end of the body section 2. The tapered segment 31 is formed on the resilient section 3, is located adjacent to the first end of the resilient section 3, is tapered toward the first end of the resilient section 3 and extends deeply into the second end of the body section 2. The tapered segment 31 has two opposite inclined sides.

The inclined gaps 22 are longitudinal, are defined in the second end of the body section 2 and are located respectively to the opposite sides of the resilient section to increase a resilience of the resilient section 3. The inclined gaps 22 may be located respectively outside and adjacent to the inclined sides of the tapered segment 31 of the resilient section 3. The inclined gaps 22 are inclined gradually inward toward each other as the inclined gaps 22 extends gradually into the second end of the body section 2 to form the tapered segment 31 of the resilient section 3. Because the inclined gaps 22 form the tapered segment 31, the first end of the resilient section 3 becomes thin to improve the resilience of the resilient section 3. Furthermore, the resilient section 3 is lengthened because the tapered segment 31 extends deeply into the second end of the body section 2, which also improves the resilience of the of the resilient section 3.

The contacting section 4 is curved, bends to be U-shaped, is formed on and extends from the second end of the resilient section 3, may contact one electrode of a battery and has a first end and a second end. The first end of the contacting section 4 is connected to the second end of the resilient section 3.

The tapered segment 31 extending deeply into the second end of the body section 2 increases a length of the resilient section 3 even though a length of the whole contact does not increase. Accordingly, the contact of the present invention with the lengthened resilient section 3 becomes more resilient as compared with a conventional contact in a battery connector with a length equal to that of the contact of the present invention.

As the contact of the present invention is sized to have the length of the resilient section 3 being the same as that of the conventional contact, the length of the contact of the present invention is shorter than that of the conventional contact. Therefore, the contact of the present invention is more compact and has a lower material cost as compared with the conventional contact.

Furthermore, cutting the inclined gaps 22 does not shorten the body section 2 so the body section may still engage firmly with the insulating compound to securely mount the contact on the PCB.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A contact for a battery connector, the contact comprising:
a soldering section;
a body section extending from the soldering section and having two opposite sides;
a resilient section, extending from the body section and having two opposite sides;
two opposite inclined gaps defined respectively in the opposite sides at the second end of the body section; and
a contacting section extending from the resilient section.

2. The contact as claimed in claim 1, wherein:
the body section has a first end connected to the soldering section and a second end;
the resilient section has a first end connected to the second end of the body section and a second end; and
the gaps are located respectively adjacent to the opposite sides of the resilient section.

3. The contact as claimed in claim 2, wherein the resilient section further has a tapered segment formed on the resilient section, located adjacent to and tapered toward the first end of the resilient section, extending deeply into the second end of the body section and having two opposite inclined sides; and
the inclined gaps are located respectively outside and adjacent to the inclined sides of the tapered segment of the resilient section and are inclined gradually inward toward each other as the inclined gaps extends gradually into the second end of the body section to form the tapered segment.

4. The contact as claimed in claim 3, wherein:
the resilient section is U-shaped; and
the contacting section is U-shaped.

5. The contact as claimed in claim 4, wherein the body section further has two notches transversely defined respectively in the sides of the body section.

6. The contact as claimed in claim 5, wherein the notches in the body section are V-shaped.
